(19) United States
(12) Patent Application Publication
(10) Pub. No.: US 2014/0237612 A1
(43) Pub. Date: Aug. 21, 2014

(54) PRIVACY SETTING IMPLEMENTATION IN A CO-BROWSING ENVIRONMENT

(71) Applicant: AVAYA INC., Basking Ridge, NJ (US)

(72) Inventors: Gaurav Moreshwar Badge, Pune (IN); Deep Subhash Pai, Pune (IN); Raman Adlakha, Pune (IN); Aprajita Lal, Banaglore (IN)

(73) Assignee: AVAYA INC., Basking Ridge, NJ (US)

(21) Appl. No.: 13/771,415

(22) Filed: Feb. 20, 2013

(51) Int. Cl. G06F 21/60

(52) U.S. Cl. CPC G06F 21/60
USPC 726/26

(57) ABSTRACT

Embodiments described herein provide systems and method for implementing privacy control in a co-browsing environment. In a particular embodiment, a method provides receiving an instruction in a co-browsing server to initiate a co-browsing session for a website with a first client and a second client. The method further provides receiving first privacy settings from the first client, wherein the first privacy settings indicate how the website should be presented at the second client. The method further provides presenting the website at the first client and presenting the website at the second client based on the first privacy settings.

### TECHNICAL BACKGROUND

Modern websites allow a user to accomplish a myriad of tasks online from the user's computing device whether the device be a laptop, desktop, smartphone, tablet, or otherwise. These tasks may include retrieving information, purchasing items, creating content, communicating with other users, or any other online activity. While a website allows a user to accomplish one or more tasks, the website does not allow for multiple users to have the same experience without those users present at the same computing device.

To address the above issue, co-browsing systems exist that allow multiple devices to view interactions with a website across the multiple devices. However, this co-browsing functionality provides that whatever content is seen or manipulated on one device may also be seen and manipulated on the other device. Thus, any website content that the user of one device may wish to keep private will still be displayed to a user of another device.

### OVERVIEW

Embodiments described herein provide systems and methods for implementing privacy control in a co-browsing environment. In a particular embodiment, a method provides receiving an instruction in a co-browsing server to initiate a co-browsing session for a website with a first client and a second client. The method further provides receiving first privacy settings from the first client, wherein the first privacy settings indicate how the website should be presented at the second client. The method further provides presenting the website at the first client and presenting the website at the second client based on the first privacy settings.

In some embodiments, the method provides, in the first client, receiving user input indicating the first privacy settings.

In some embodiments, the method provides that the first privacy settings indicate at least one portion of the website that should be obscured when viewed at the second client and that presenting the website on the second client based on the first privacy settings comprises, in the second client, displaying the website and obscuring the at least one portion of the website that should be obscured.

In some embodiments, the method provides that the privacy setting indicate at least one portion of the website that should not accept user input at the second client and that presenting the website on the second client based on the first privacy settings comprises, in the second client, displaying the website and not accepting user input into the at least one portion of the website that should not accept user input.

In some embodiments, the method provides, in the first client, displaying an indication of possible privacy settings for the website.

In some embodiments, the method provides that the indication of possible privacy settings includes user selectable privacy levels for each portion of the website subject to the possible privacy settings, and further comprises, in the first client, receiving user input selecting the user selectable privacy levels and transferring the first privacy settings to the co-browsing server based on the user input.

In some embodiments, the method provides that the indication of possible privacy settings further includes a default configuration of the user selectable privacy levels.

In some embodiments, the method provides storing the first privacy settings for use with other websites.

In some embodiments, the method provides receiving second privacy settings from the first client after receiving the first privacy settings, wherein the second privacy settings indicate how the website should be presented at the second client, and presenting the website at the second client based on the second privacy settings.

In some embodiments, the method provides rendering the website in the co-browsing server to generate a rendered image of the website, generating a first copy of the rendered image and a second copy of the rendered image, and applying the privacy settings to the second copy of the rendered image. The method also provides transferring the first copy of the rendered image to the first client and the second copy of the rendered image to the second client, wherein presenting the website at the first client comprises displaying the first copy of the rendered image at the first client and wherein presenting the website at the second client based on the first privacy settings comprises displaying the second copy of the rendered image at the second client.

In another embodiment, a co-browsing server is provided that includes a communication interface configured to receive an instruction in a co-browsing server to initiate a co-browsing session for a website with a first client and a second client and receive first privacy settings from the first client, wherein the first privacy settings indicate how the website should be presented at the second client. The server further includes a processing system configured to enable presentation of the website at the first client and presentation of the website at the second client based on the first privacy settings.

### BRIEF DESCRIPTION OF THE DRAWINGS

FIG. 1 illustrates a co-browsing system for implementing privacy control in a co-browsing environment.

FIG. 2 illustrates an operation of the co-browsing system for implementing privacy control in a co-browsing environment.

FIG. 3 illustrates a co-browsing system for implementing privacy control in a co-browsing environment.

FIG. 4 illustrates an operation of the co-browsing system for implementing privacy control in a co-browsing environment.

FIG. 5 illustrates a browser window for implementing privacy control in a co-browsing environment.

FIG. 6 illustrates a browser window for implementing privacy control in a co-browsing environment.

FIG. 7 illustrates a browser window for implementing privacy control in a co-browsing environment.

FIG. 8 illustrates a browser window for implementing privacy control in a co-browsing environment.

FIG. 9 illustrates a co-browsing server for allowing multiple devices to browse the same instance of a website.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

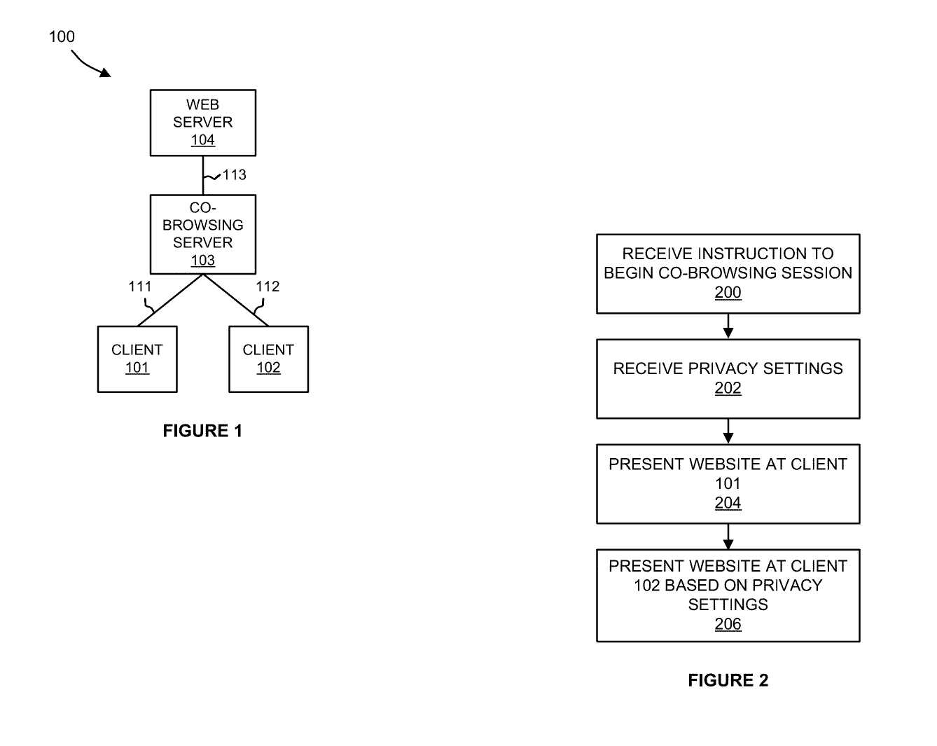

FIG. 1 illustrates co-browsing system 100. Co-browsing system 100 includes client 101, client 102, co-browsing server 103, and web server 104. Client 101 and co-browsing server 103 communicate over communication link 111. Client 102 and co-browsing server 103 communicate over communication link 112. Co-browsing server 103 and web server 104 communicate over communication link 113.

In operation, clients 101 and 102 are executing on computing devices, such as laptop computers, desktop computers, tablet computers, and smartphones. Clients 101-102 may be executing within a web browsing application that is also executing on their respective computing devices or may be independent applications. Clients 101 and 102 may be installed as extensions or plugins within their respective web browsers or software for the clients may be transferred from co-browsing server 103 as needed. Client software may take the form of a web standard, such as HTML 5 or Java, so that the web browser on a device does not require additional plugins or extensions in order to execute clients 101 and 102. Alternatively, the client software may comprise a stand alone application or take some other form depending on the co-browsing platform used by co-browsing server 103. While a typical web browsing application is able to retrieve a website from web server 104, clients 101 and 102 allow for their respective users to view each other's interactions with a website from web server 104.

In some embodiments, clients 101 and 102 each render the website separately for display while in other embodiments co-browsing server 103 renders the website and transfers a rendered image of the website to clients 101 and 102 for display. Other methods of performing a co-browsing session may also be used. Clients 101 and 102 exchange communication with co-browsing server 103 to synchronize website interactions across clients 101 and 102. For example, if a user types information into the website on client 101, that information will also show as being entered into the website on client 102.

FIG. 2 illustrates the operation of co-browsing system 100 for implementing privacy control in a co-browsing environment. Co-browsing server 103 receives an instruction to initiate a co-browsing session for a website with a first client and a second client (step 200). The instruction may include a web address for retrieving the website from web server 104, identifiers for clients that will participate in the co-browsing session, and any other information that may be useful when establishing a co-browsing session. The instruction may be received from the computing device executing either client 101 or client 102. The instruction may be transferred in response to a user input. For example, a user of a first computing device may select a link in a website, email message, or elsewhere, that directs the first computing device to open client 1 and connect with co-browsing server 103. Alternatively, the user may open client 1 and indicate within client 1 that the user desires to establish a co-browsing session of a website by providing the website and identifiers for other clients that will participate the session.

Co-browsing server 103 further receives privacy settings from client 101, wherein the first privacy settings indicate how the website should be presented at client 102 (step 202). The privacy settings may include parameters indicating how the website should be displayed to a user at client 102 and/or parameters limiting the ability of the user at client 102 to interact with the website. For example, the parameters may indicate one or more elements of the website that should be obscured from view at client 102 and indicate input fields or links of the website that should not receive input at client 102. Before being transferred to and received by co-browsing server 103, the privacy settings may be received by client 101 in any manner that a user may employ to enter information into a client executing on a device. Client 101 may prompt the user to enter privacy settings or the privacy settings may be entered by the user on the user's own accord. Likewise, client 101 may provide the user with default privacy settings. The default privacy settings may be based upon common co-browsing privacy settings for the website or other websites. The user may accept the default settings or modify the default settings as desired.

Client 101 presents the website to the user(s) of client 101 (step 204). The website may be retrieved from web server 104 with or without being transferred through co-browsing server 103 and then rendered at client device 101. The rendering engine used at client 101 may be the same as or different than the rendering engine used at client 102. Alternatively, co-browsing server 103 may receive the website from web server 104, render the website, and transfer the rendered website image to client 101. Other methods of presenting websites in a co-browsing environment may also be used. A rendering engine uses content information and formatting information to generate an image of a website. The content information may be received from web server 104 in HyperText Markup Language (HTML), Extensible Markup Language (XML), image files, or some other format—including combinations thereof. The formatting information may be received from web server 104 in Cascading Style Sheets (CSS), Extensible Stylesheet Language (XSL), or some other format—including combinations thereof. Examples of a browser engine may include Webkit, Gecko, Trident, or any other browser engine.

The user of client 101 may enter the privacy settings before or after the website is displayed by client 101. In an embodiment, client 101 displays the website and overlay options for privacy settings of various elements of the website so that the user can select desired options. After selecting the desired options, client 101 may provide an ongoing indication of the privacy settings so that the user of client 101 is cognizant of the current privacy settings.

The website is also presented at client 102 based on the privacy settings (step 206). Accordingly, the website may not be presented at client 102 until after the privacy settings are received in co-browsing server 103. In embodiments where client 102 renders the website itself, client 102 receives the privacy settings and applies the privacy settings to the rendered website when presenting the website to a user(s) of client 102. In embodiments where co-browsing server 102 renders the website, co-browsing server 102 may apply some portions of the privacy settings (from none up to all of the privacy settings) to the rendered website before transferring the website image to client 102 where any remaining portions of the website are applied. Thus, if the privacy settings indicate portions of the website that should be obscured at client 102, then those portions are obscured when displayed at client 102. Likewise, if the privacy settings indicate portions of the website that should not accept user input at client 102, then client 102 or co-browsing server 103 ensures that those elements do not accept input from the user of client 102. The privacy settings may be transferred to client 102 from co-browsing server 103 in metadata for the website, metadata for the co-browsing session, in a separate message, or some other means of transferring electronic information.

In some embodiments, co-browsing server 103 and/or client 101 may store the privacy settings for later use. The stored privacy setting may therefore be used when the user of client 101 directs client 101 the website in another co-browsing session. Similarly the privacy settings may be applied to co-browsing sessions of other websites. In those embodiments, co-browsing server 103 or client 101 may recognize elements of the website for which the privacy settings were originally configured and then apply the same privacy settings to similar elements of another website. For example, the stored privacy settings may be configured to obscure credit card information on the website for which the settings were configured. Upon navigating client 101 to another website for co-browsing, if a credit card information field is detected in that other website, then the privacy settings will obscure the credit card information in the other website as well. The user of client 101 may have to provide an indication to client 101 that the user desires the privacy settings to be stored and/or desires that the privacy settings be used on other websites.

In some embodiments, co-browsing system 100 may continue to accept changes to the privacy settings from the user of client 101. In those embodiments, upon receiving changed privacy settings, co-browsing system 100 will present the website at client 102 based on the changed privacy settings. For example, the user of client 101 may change his or her mind about the privacy settings after the settings were originally entered, such as wanting an element to be obscured that was originally viewable at client 102. The user of client 101 would therefore indicate the desired change in client 101 so that client 102 no longer displays the element. The user may be allowed to make any further changes to the privacy settings as well.

It should be understood that while the embodiments discussed above include only two clients, the embodiments could be expanded to include any number of clients. In those expanded embodiments, the privacy settings received at client 101 may apply identically to client 102 and any additional clients or the user of client 101 may enter alternative privacy settings for one or more of the additional clients.

Referring back to FIG. 1, clients 101 and 102 are executing on respective computing devices that each comprise computer processing circuitry and communication circuitry. The communication circuitry may be wireless, wireline, or both. The computing devices may each also include a user interface, memory device, software, or some other communication components. The computing devices may each be a telephone, computer, e-book, mobile Internet appliance, media player, game console, or some other computing apparatus—including combinations thereof.

Co-browsing server 103 comprises a computer system and a communication interface. Co-browsing server 103 may also include other components such a router, data storage system, and power supply. Co-browsing server 103 may reside in a single device or may be distributed across multiple devices. Co-browsing server 103 is shown externally to web server 104, but co-browsing server 103 could be integrated within the components of web server 104.

Web server 104 comprises a computer system and communication interface. Web server 104 may also include other components such a router, data storage system, power supply, and any further components that may be used for providing websites to web browsing applications. Web server 104 may reside in a single device or may be distributed across multiple devices.

Communication links 111-113 use metal, glass, air, space, or some other material as the transport media. Communication links 111-113 could use various communication protocols, such as Time Division Multiplex (TDM), Internet Protocol (IP), Ethernet, communication signaling, CDMA, EVDO, WIMAX, GSM, LTE, WIFI, HSPA, or some other communication format—including combinations thereof. Communication links 111-113 could be direct links or may include intermediate networks, systems, or devices.

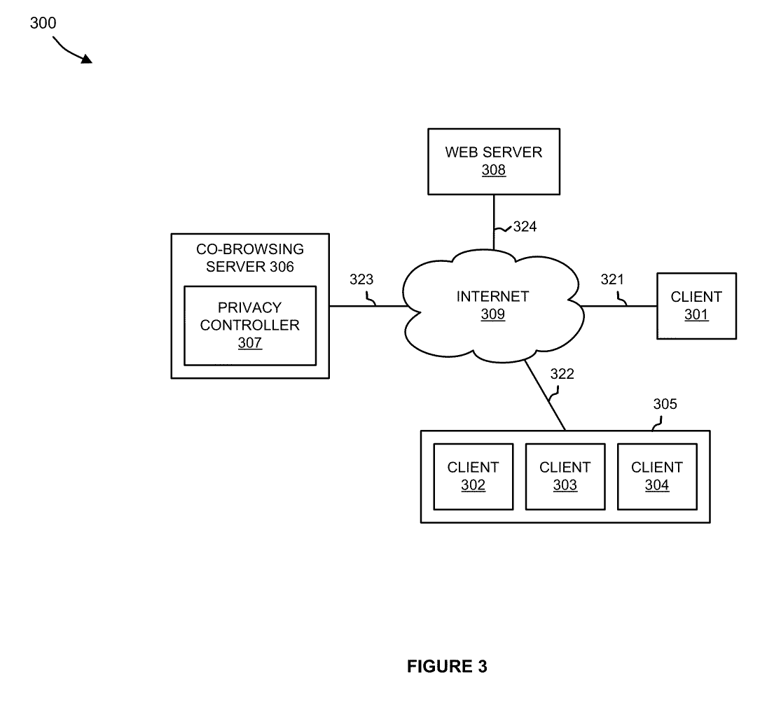

FIG. 3 illustrates co-browsing system 300. Co-browsing system 300 includes client 301, clients 302-304 located within support center 305, co-browsing server 306, web server 308, and Internet 309. Co-browsing server 306 includes privacy controller 307. Client 301 and Internet 308 communicate over communication link 321. Support center 305 and Internet 308 communicate over communication link 322. Co-browsing server 306 and Internet 308 communicate over communication link 323. Web server 324 and Internet 308 communicate over communication link 324.

While shown separately, web server 307 and co-browsing server 306 may be incorporated within one another or may be collocated such that they communicate over a local area network rather than Internet 308. Similarly, support center 305 and either web server 307, co-browsing server 306, or both may be collocated. Alternatively, support center 305 may be a virtual center with clients 302-304 distributed in multiple locations and accessing Internet 308 on separate links. Additionally, client 301, support center 305, co-browsing server 306, web server 307 may access Internet 308 through one or more access providers.

In operation, agents operate clients 302-304 to assist customers or, some other types of user, with issues that the customer may have. In some embodiments, support center 305 may be associated with an entity from which the customer requires support. For example, web server 308 may include a website for a company and support center 305 provides support to customers using the company's website. If necessary, co-browsing server 306 may be used for an agent operating one of clients 302-304 to provide the customer with website support.

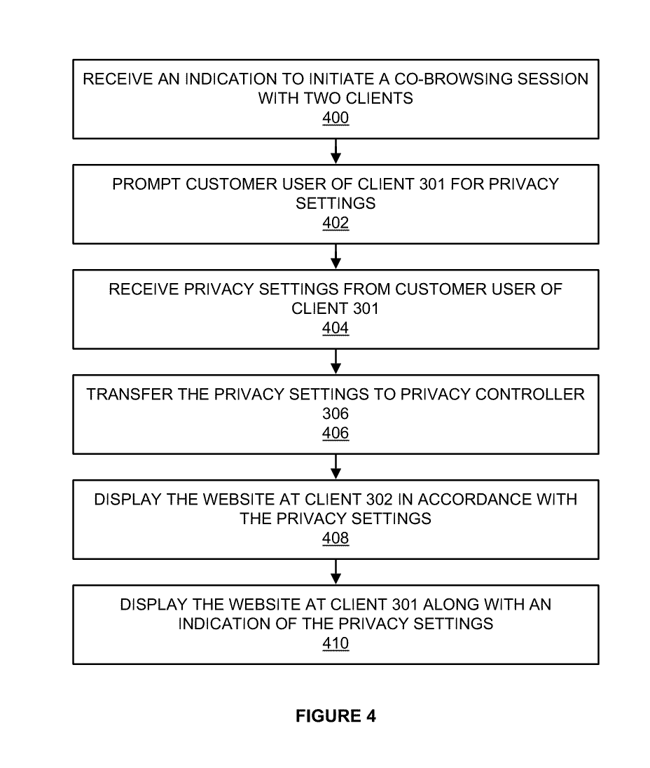

FIG. 4 illustrates the operation of co-browsing system 300 for implementing privacy control in a co-browsing environment. Co-browsing system receives an indication to initiate a co-browsing session between two clients (Step 400). In this example, a customer that is operating client 301 desires to participate in a co-browsing session with an agent operating one of clients 302-304 in support center 305. The desire may arise from difficulty navigating a website provided by web server 307, from a lack of knowledge of the website's features, or for any other reason that the customer may desire assistance.

The indication to initiate the co-browsing session may be received from an agent of support center 305 or from a customer. For example, the customer may click a link on a web page, or elsewhere, that initiates the co-browsing session with an agent. Similarly, if a customer is already communicating with an agent, then the agent may transfer a link to the client for the client to initiate the co-browsing session. The link may be transferred over email, instant messaging, client-to-client messaging, or any other way of transferring a link. The content of the link may be generated by co-browsing system 306 itself, by a client, by web server 307, or by some other system or application. The information necessary to initiate the co-browsing session may be included in the link, may direct co-browsing server 306 to a location containing the information, may be a code that correspond to parameters created for the co-browsing session, or any other method of providing the co-browsing server with information necessary to initiate a co-browsing session.

In this embodiment, the request to initiate a co-browsing session indicates to co-browsing server 301 should initiate a co-browsing session between client 301 and client 302. Client 302 may be selected from support center clients 302-304 based on the agent operating client 302 already communicating with the customer operating client 301. Alternatively, if the agent is not already communicating with the customer, then a client may be randomly chosen, selected based on an agent distribution algorithm, or some other method for selecting a support center agent. An agent may communicate with the customer over using a traditional voice phone, a web call, a video conference, a chat window displayed in a web browser window or elsewhere, or any other means of communicating between two parties.

After receiving the co-browsing request, client 301 prompts the customer to enter privacy settings (step 402) and receives privacy settings from the customer. The prompt may be presented in any way that a client executing on a computing device can prompt a user, such as a visual indicator(s) or an audio indicator(s). In one example, client 301 may display the requested website with indicators corresponding to portions of the website that can be subject to privacy settings and may also indicate what settings are possible for each portion. In such examples, client 301 or privacy controller 306 determines which portions of the website can be subject to privacy settings so that the indicators have proper correspondence. In another example, the user may indicate manually indicate the portions of the website subject to privacy settings, such as by selecting (i.e. using a mouse cursor, touchscreen, etc.) a portion of the website and indicating which privacy setting should apply to the selected portion. In yet another example, client 101 may present a list of the types of fields that will be displayed in the website and the user can select the privacy settings for each field type from the list. It should be understood that any other method of entering privacy setting parameters into a client executing on a computing device may be used.

After receipt from the customer, the privacy settings are transferred from client 301 to privacy controller 307 (step 406). Upon receiving the privacy settings, privacy controller 307 implements the privacy settings for presenting the website to the agent operating client 302. In one embodiment, privacy controller 307 transfers the privacy settings to client 302 in addition to website information that client 302 uses to render the website. Client 302 then uses the privacy settings to present the rendered website to the agent in accordance with the customer's wishes. In another embodiment, co-browsing server may render the website information itself and transfer the rendered website image to client 302. In that embodiment, privacy controller 307 may apply the privacy settings to the rendered image before transferring the rendered image to client 302 or may transfer the privacy settings to client 302 along with the image to client 302 for application of the settings by client 302. In further embodiments, the privacy settings may be applied by modifying the website information itself before the website is rendered by either co-browsing server 306 or client 302.

After the privacy settings are applied, client 302 displays the website in accordance with the privacy settings (step 408). If the privacy settings were previously applied to the website by privacy controller 307, then client 302 presents the website to the agent as received from privacy controller 307. If the privacy settings were transferred to client 302 for application by client 302, then client 302 applies the privacy settings to the website when presenting the website to the agent. The privacy settings may be transferred to client 302 from privacy controller 307 in metadata for the website, metadata for the co-browsing session, in a separate message, or some other means of transferring electronic information. Accordingly, the website may be received by client 302 from web server 308 directly or via co-browsing server 306.

The website is also presented at client 301 with an indication of the privacy settings (step 410). The privacy settings may be indicated in any manner in which information can be presented to a user of a client executing on a computing device. In a particular embodiment, an indicator of a privacy setting for each portion of the website may be positioned near the displayed website portion. In another embodiment, the privacy settings may be presented in a toolbar for client 301 or elsewhere within client 301. Furthermore, the customer operating client 301 may be able to change the privacy settings during the co-browsing session as desired.

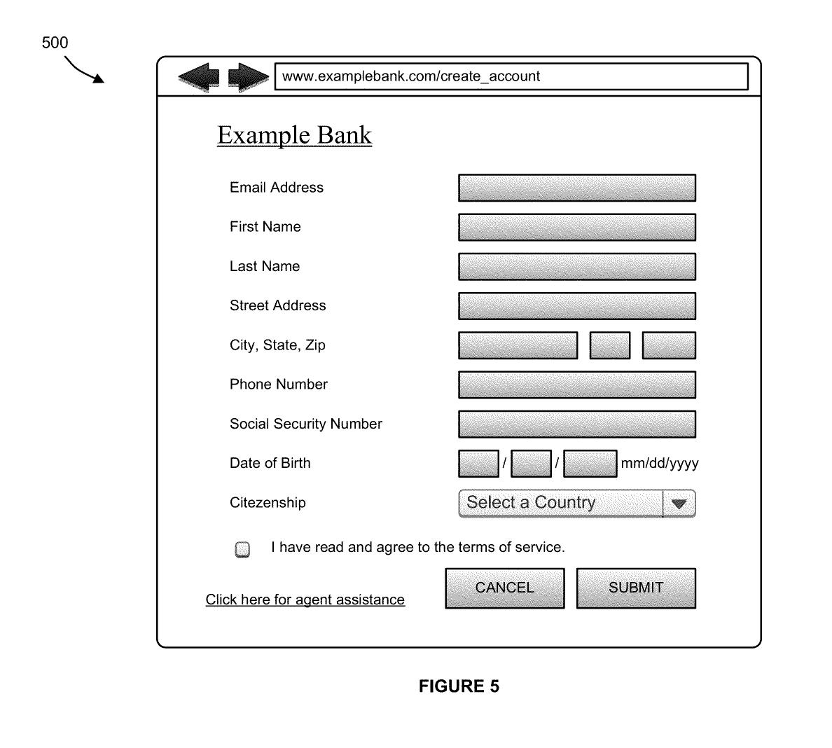

FIG. 5 illustrates web browser window 500 in an example of the above method. Web browser window 500 is displayed on a computing device of a customer trying to order something on a website, www.examplebank.com/create_account, and is a window of a web browser application executing on the computing device. The website is retrieved by the web browser from web server 308 without using co-browsing server 306 since a co-browsing session has not yet been initiated. Likewise, after receiving the website, the web browser application itself renders the website for display in window 500.

In this example, the customer is currently viewing the account creation form page of the website. The lower left corner of window 500 displays a link so that the customer clicks on the link to receive agent assistance with the website. Upon selecting the link, a message is sent to co-browsing server 306 to initiate a co-browsing session with an agent of the web site. In addition to initializing a co-browsing session for the website, the link may open a chat window so that the customer can interact with the agent with which the customer will be co-browsing. Alternatively, the customer may be prompted to provide a telephone number so that the agent can call the customer during the co-browsing session. Other forms of communication between the customer and the agent may also be used.

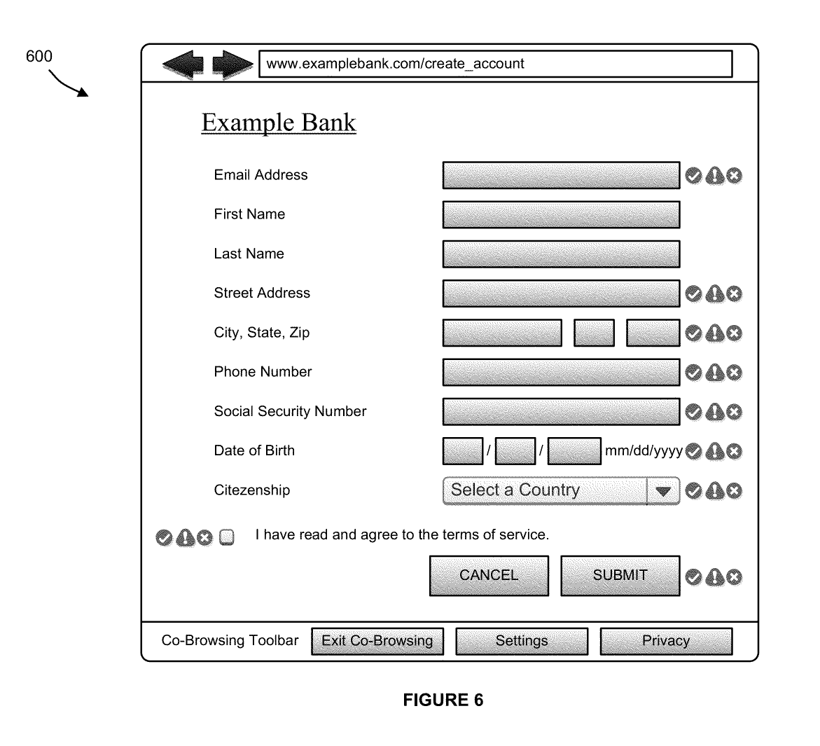

FIG. 6 illustrates web browser window 600 displaying the website to the customer during a co-browsing session. Co-browsing server 306 may receive indication that the customer clicked the link by receiving a message from web server 308 that the link was clicked, the link itself may have directed to co-browsing server 306, or any other method that an indication may be routed to co-browsing server 306.

After receiving notification that the customer clicked on the link, co-browsing server transfers information needed for the web browser on the customer's device to execute co-browsing client 301. The information may include the software for client 301 itself if client 301 is not already installed in the customer's web browser. Co-browsing client 301 may execute in web browser window 600 using standard web protocols, such as HTML5, so that the web browser does not need any plugins, extensions, or other modification to run client 301. Alternatively, client 301 may execute using Java, Flash, or any other type of web environment. Web browser window 600 may be the same web browser window as web browser window 500 or may be a new window opened in response to the customer clicking the link.

The co-browsing toolbar at the bottom of web browser window 600 indicates to the customer that web browser window 600 is displaying and executing client 301. While FIG. 6 displays the toolbar for client 301 at the bottom of window 600, the toolbar may assume any other position and take any other form to indicate that client 301 is executing. In addition to indicating that client 301 is executing, the toolbar may provide options for controlling client 301. For example, the co-browsing toolbar of FIG. 6 displays buttons to exit the co-browsing session, bring up a settings menu, and enable/disable privacy settings. Exiting the co-browsing session closes client 301 after which web browser window 600 may be closed as well, reload the co-browsed website normally, go to a start page, or any other type of action that can be taken by a web browser. The settings menu may include options for display resolution of web pages, privacy settings for filters 310 and 312 in co-browsing server 306, or any other options that may be beneficial for a user in a co-browsing session. The privacy button may be enabled or disabled by default upon executing client 301.

Window 600 illustrates that the privacy settings are enabled in client 301 by presenting privacy options to the customer. In this example, there are three possible privacy options for each field, although, in other embodiments, the possible privacy options may differ for each field. The three possible privacy options provided will either allow the agent to view and edit the corresponding field of the website, as represented by the check mark, allow the agent to view but not edit the corresponding field, as represented by the exclamation mark, or not allow the agent to view or to edit the corresponding field, as represented by the ‘x’ mark. The customer indicates a privacy setting for each of the corresponding fields by selecting the desired marker next to each field. If a setting is not indicated for every field, then a default setting for that field may be used.

Window 600 does not display privacy options next to the “First Name” or “Last Name” fields because, in this example, a co-browsing server 306, support center 305, or web server 308 administrator has indicated that the name fields should always be visible to agents during co-browsing sessions. The administrator may also have defined the possible privacy settings for each of the other fields of the website.

After the privacy settings are entered by the customer, the settings are transferred to privacy controller 307 so that the privacy settings can be applied to the website when presented to the agent at client 302.

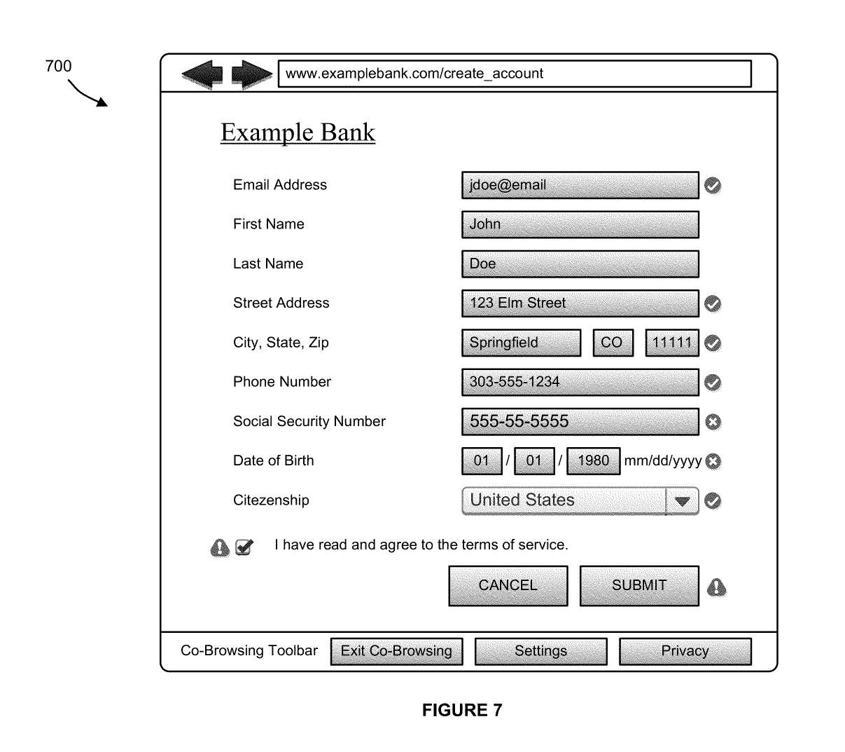

FIG. 7 illustrates web browser window 700 displaying the website to the customer during the co-browsing session after the privacy settings have been entered. Thus, window 700 may be an example of window 600 after the customer selects the desired privacy settings. Window 700 illustrates the website along with an indication of the selected privacy setting for each field. The customer may be able to change the privacy setting for a field during the co-browsing session. For example, the customer may select the setting indicator corresponding to a field and client 302 may present other privacy setting options for that field so that the customer can select a different setting.

Window 700 further illustrates that information has been entered into the website. Since client 301 is currently involved in a co-browsing session, the agent or the customer may have entered the information in fields with a corresponding checkmark with co-browsing server 306 synchronizing the information across clients 301 and 302. The synchronization may occur in real time so that the users of both clients 301 and 302 are aware of what the other is doing at any given time. In accordance with the privacy settings, client 301 is the client that entered information into fields with a corresponding ‘x’ mark since the agent at client 302 can neither see nor edit those fields. Also, client 301 must have received the selection of the checkbox since the agent can view the check box but not edit the check box. Likewise, when the customer and the agent are satisfied with the state of the website, the privacy settings will not allow the agent at client 302 to select the submit button.

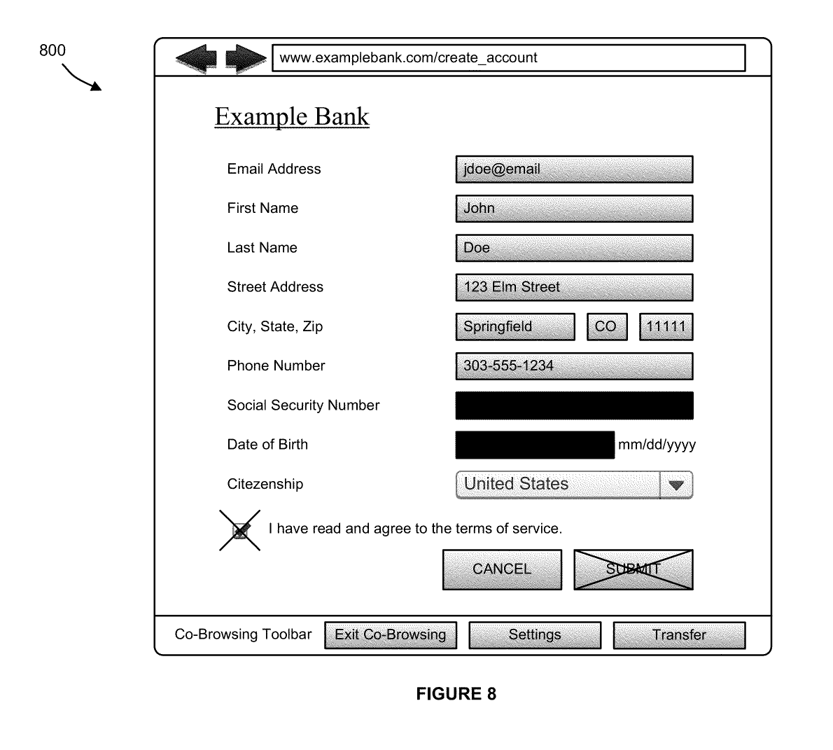

FIG. 8 illustrates web browser window 800 displaying the website to the agent during the co-browsing session after the privacy settings have been entered. Window 800 displays substantially the same website content as window 700 due to co-browsing server 306 synchronizing the website across clients 301 and 302. However, in accordance with the privacy settings indicated in window 700, client 302 executing in window 800 blocks the agent from viewing the social security number (SSN) and date of birth (DOB) fields in the displayed website, thereby keeping that information private for the customer. While client 302 is illustrated as blacking out the portion of the website including the SSN and DOB fields, client 302 may use other methods of obscuring that information from view, such as using an alternative character in place of the digits entered in each field. Client 302 also indicates that the agent does not have the ability to check the terms of service box or to select the submit button. Client 302 does this by crossing out the checkbox and the submit button, however, any other method(s) of indication may also be used. Alternatively, no indication need be provided and any input into the checkbox or submit button is not acted upon by co-browsing system 300 and after such non action, a notification is displayed at client 302 that the action is not permitted.

The toolbar for client 302 shown at the bottom of browser window 700 is similar to the toolbar of client 301. However, client 302 also has a transfer button. The transfer button allows the agent to transfer the co-browsing session to another agent. Thus, the agent may press the transfer button and indicate that co-browsing session should be transferred to the agent operating client 304. Upon receiving notification of the transfer, co-browsing 306 server performs necessary actions to provide the website to client 304 as well.

In some embodiments, the transfer button, or a separate button, may also provide the agent with the ability to conference one or more other agents into the co-browsing session. For example, the agent operating client 302 may indicate that the agent operating client 304 should be included in the co-browsing session. In response to the indication, co-browsing server 306 performs necessary action to provide the website to client 304 while still provided the website to client 302. Thus, client 302 continues to participate in the session along with client 301 and 304 as a three party co-browsing session.

In the embodiments where client 304 enters the co-browsing session, client 301 may prompt the customer to request privacy settings for the agent operating client 304. The prompt may be similar to the prompt described above in FIG. 6 to enter new privacy settings or to continue the privacy settings used for client 302 with client 304, although, other forms of prompting the customer at client 301 may also be used. Accordingly, the privacy settings for client 304 may be the same as or different than the privacy settings for client 302.

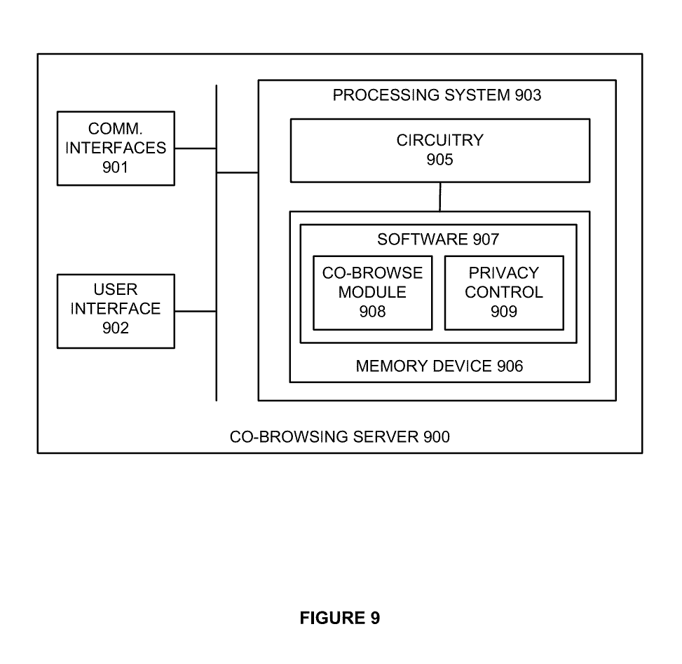

FIG. 9 illustrates co-browsing server 900. Co-browsing server 900 is an example of co-browsing server 103, although server 103 may use alternative configurations. Co-browsing server 900 comprises communication interface 901, user interface 902, and processing system 903. Processing system 903 is linked to communication interface 901 and user interface 902. Processing system 903 includes processing circuitry 905 and memory device 906 that stores operating software 907.

Communication interface 901 comprises components that communicate over communication links, such as network cards, ports, RF transceivers, processing circuitry and software, or some other communication devices. Communication interface 901 may be configured to communicate over metallic, wireless, or optical links. Communication interface 901 may be configured to use TDM, IP, Ethernet, optical networking, wireless protocols, communication signaling, or some other communication format—including combinations thereof.

User interface 902 comprises components that interact with a user. User interface 902 may include a keyboard, display screen, mouse, touch pad, or some other user input/output apparatus. User interface 902 may be omitted in some examples.

Processing circuitry 905 comprises microprocessor and other circuitry that retrieves and executes operating software 907 from memory device 906. Memory device 906 comprises a non-transitory storage medium, such as a disk drive, flash drive, data storage circuitry, or some other memory apparatus. Operating software 907 comprises computer programs, firmware, or some other form of machine-readable processing instructions. Operating software includes co-browsing module 908 and privacy control module 909. Operating software 907 may further include an operating system, utilities, drivers, network interfaces, applications, or some other type of software. When executed by circuitry 905, operating software 907 directs processing system 903 to operate co-browsing server 900 as described herein.

In particular, co-browsing module 908 directs processing system 903 to receive an instruction in the co-browsing system via communication interface 901 to initiate a co-browsing session for a website with a first client and a second client. Privacy control module 909 directs processing system 903 to receive first privacy settings via communication interface 901 from the first client, wherein the first privacy settings indicate how the website should be presented at the second client. Co-browsing module 908 directs processing system 903 to enable presentation of the website at the first client. Co-browsing module 908 and privacy control module 909 direct processing system 903 to enable presentation of the website at the second client based on the first privacy settings.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a co-browsing system, comprising:
receiving an instruction in a co-browsing server to initiate a co-browsing session for a website with a first client and a second client;
receiving first privacy settings from the first client, wherein the first privacy settings indicate how the website should be presented at the second client;
presenting the website at the first client; and
presenting the website at the second client based on the first privacy settings.

2. The method of claim 1, further comprising:
in the first client, receiving user input indicating the first privacy settings.

3. The method of claim 1, wherein the first privacy settings indicate at least one portion of the website that should be obscured when viewed at the second client and wherein presenting the website on the second client based on the first privacy settings comprises:
in the second client, displaying the website and obscuring the at least one portion of the website that should be obscured.

4. The method of claim 1, wherein the privacy setting indicate at least one portion of the website that should not accept user input at the second client and wherein presenting the website on the second client based on the first privacy settings comprises:
in the second client, displaying the website and not accepting user input into the at least one portion of the website that should not accept user input.

5. The method of claim 1, further comprising:
in the first client, displaying an indication of possible privacy settings for the website.

6. The method of claim 5, wherein the indication of possible privacy settings includes user selectable privacy levels for each portion of the website subject to the possible privacy settings, and further comprising:
in the first client, receiving user input selecting the user selectable privacy levels and transferring the first privacy settings to the co-browsing server based on the user input.

7. The method of claim 6, wherein the indication of possible privacy settings further includes a default configuration of the user selectable privacy levels.

8. The method of claim 1, further comprising:
storing the first privacy settings for use with other websites.

9. The method of claim 1, further comprising:
receiving second privacy settings from the first client after receiving the first privacy settings, wherein the second privacy settings indicate how the website should be presented at the second client; and
presenting the website at the second client based on the second privacy settings.

10. The method of claim 1, further comprising:
rendering the website in the co-browsing server to generate a rendered image of the website;
generating a first copy of the rendered image and a second copy of the rendered image;
applying the privacy settings to the second copy of the rendered image;
transferring the first copy of the rendered image to the first client and the second copy of the rendered image to the second client;
wherein presenting the website at the first client comprises displaying the first copy of the rendered image at the first client; and
wherein presenting the website at the second client based on the first privacy settings comprises displaying the second copy of the rendered image at the second client.

11. A co-browsing server, comprising:
a communication interface configured to receive an instruction in a co-browsing server to initiate a co-browsing session for a website with a first client and a second client and receive first privacy settings from the first client, wherein the first privacy settings indicate how the website should be presented at the second client;
a processing system configured to enable presentation of the website at the first client and presentation of the website at the second client based on the first privacy settings.

12. The co-browsing server of claim 11, wherein the first client receives user input indicating the first privacy settings.

13. The co-browsing server of claim 11, wherein the first privacy settings indicate at least one portion of the website that should be obscured when viewed at the second client and wherein the second client displays the website and obscures the at least one portion of the website that should be obscured.

14. The co-browsing server of claim 11, wherein the privacy setting indicate at least one portion of the website that should not accept user input at the second client and wherein the second client displays the website and does not accept user input into the at least one portion of the website that should not accept user input.

15. The co-browsing server of claim 11, wherein the first client displays an indication of possible privacy settings for the website.

16. The co-browsing server of claim 15, wherein the indication of possible privacy settings includes user selectable privacy levels for each portion of the website subject to the possible privacy settings and wherein the first client receives user input selecting the user selectable privacy levels and transfers the first privacy settings to the co-browsing server based on the user input.

17. The co-browsing server of claim 16, wherein the indication of possible privacy settings further includes a default configuration of the user selectable privacy levels.

18. The co-browsing server of claim 11, further comprising:
a storage system configured to store the first privacy settings for use with other websites.

19. The co-browsing server of claim 11, further comprising:
receiving second privacy settings from the first client after receiving the first privacy settings, wherein the second privacy settings indicate how the website should be presented at the second client; and
presenting the website at the second client based on the second privacy settings.

20. The co-browsing server of claim 11, further comprising:
the processing system configured to render the website in the co-browsing server to generate a rendered image of the website, generate a first copy of the rendered image and a second copy of the rendered image, and apply the privacy settings to the second copy of the rendered image;
the communication interface configured to transfer the first copy of the rendered image to the first client and the second copy of the rendered image to the second client, wherein the first client displays the first copy of the rendered image and the second client displays the second copy of the rendered image.
